(19) United States
(12) Patent Application Publication
(10) Pub. No.: US 2007/0042739 A1
(43) Pub. Date: Feb. 22, 2007

(54) Process and diagnostic device for selective testing of receiver antennas in a multi-antenna system

(75) Inventors: Andreas Gruhle, Ulm (DE); Harmut Presting, Blaustein (DE)

Correspondence Address: AKERMAN SENTERFITT, P.O. BOX 3188, WEST PALM BEACH, FL, 33402-3188, US

(73) Assignee: DaimlerChrysler AG, Stuttgart (DE)

(21) Appl. No.: 11/506,272

(22) Filed: Aug. 16, 2006

(30) Foreign Application Priority Data
Aug. 18, 2005 (DE) 10 2005 039 526.0

(51) Int. Cl. H04B 1/06; H04B 17/00

(52) U.S. Cl. 455/277.2; 455/67.14

(57) ABSTRACT

Mobile radio reception, in particular in motor vehicles, has the disadvantage in comparison to geographically fixed home reception, that line of sight contact with the transmitter rarely exists and the signal strength near the ground is significantly smaller than the signal strength for roof-top antennas. For minimizing these disturbances, antenna diversity systems were developed. A practical problem in the realization of antenna diversity systems is comprised therein, that the diversity circuits do not support a targeted selection of individual antennas so that the individual antennas following installation can be tested for their functionality. Proposed is a process and a diagnostic device for selective testing of receiver antennas in a multi antenna system (6), which is controlled by a diversity circuit (10) and is couplable and/or coupled with a receiver (8), therein the receiver antennas are irradiated with a test signal (17), which exhibits a first signal progression segment, which brings about a reswitching of the receiver antenna by the diversity circuit (10) and includes a second signal progression segment which impedes a reselection or switching of the receiver antenna by the diversity circuit (10).

### BACKGROUND OF THE INVENTION

1. Field of the Invention

The invention concerns a process for selective testing of receiver antennas in a multi-antenna system, which are coupalable and/or coupled to a receiver via a diversity circuit, as well as a corresponding diagnostic device.

2. Description of Related Art

In contrast to geographically fixed home reception, mobile radio reception, in particular in motor vehicles, has the disadvantage that line-of-sight transmission seldom exists, and further, the field-strength at ground level is significantly weaker than the field strength as received by domestic rooftop mounted antennas. For these reasons disturbances in mobile radio reception may occur even in reception areas with good coverage. The cause for the disturbance in reception is primarily attributable to multi-path reception, caused by reflection, scattering and bending of the radio waves in the environment of the receiver, or the multi-path reception leads to delayed time differential among the partial waves, and in particular leads to interference. In addition, there are general disturbances and signal level fluctuations.

For minimizing these disturbances, antenna-diversity-systems were developed. In these systems multi-receiver antennas are employed in place of a single antenna, so that the probability is high that at least one of the receiver antennas is in a location which is not, or is less, influenced by the disturbances. A diversity switch accomplishes that, from the available receiver antennas, the receiver antenna having the least disturbance is selected to provide the received signal to the receiver. Thereby, in comparison to the conventional mono-antenna systems, an effective reduction of the diverse occurring disturbances is made possible.

A practical problem in the utilization of antenna-diversity-systems is comprised therein that the diversity circuit does not support a targeted selection of individual antennas, and accordingly the individual antennas cannot be tested for their functionality after installation.

### SUMMARY OF THE INVENTION

In order nevertheless to be able to carry out a testing of the functionality of the antennas, the antenna amplifier module could, for example, be opened and the received signals of the antennas be directly sampled. This alterative is however not realistic is practice. A further possibility would be to introduce a test signal directly into the antenna line. This however fails in practical application, since access to the antenna line is mechanically not possible, in particular when the receiver antennas are adhered to the windshield of a vehicle. Alternatively, the test signals could be directly locally introduced into the various antenna branches, for example in that a part of the antennas are covered with a screen or template. In practice however this process is difficult to realize due to the bleeding of the test signal from one antenna branch to another antenna branch.

In the publication DE 199 30 571 A1 a diagnostic device for a multi-antenna system is proposed which makes it possible to carry out a differentiated testing of the individual antennas of the multi-antenna system without direct intervention in the circuitry of the receiver equipment. A proposed diagnostic device includes a control unit, which produces a control signal, which is a IF-signal (intermediate frequency signal) which will be referred to in the following as IF-control signal. This IF-control signal is supplied to the diversity circuit in place of the normal IF-signal of the receiver. By imposing a simulated disturbance on the IF-control signal it is brought about, that the diversity circuit carries out a relay switching to the next antenna in sequence. Parallel to this, a test unit is used to supply a test signal to the antennas of the multi-antenna arrangement and the received data of the respective switched to antennas are individually measured and evaluated.

### DETAILED DESCRIPTION OF THE INVENTION

The invention is concerned with a task of providing an alternative process for testing of multi-antenna systems as well as a corresponding diagnostic device.

This task is solved by a process for selective testing of receiver antennas (antenna 0 . . . 3) in a multi-antenna system (6) which is controlled by a diversity circuit (10) and couplable and/or coupled to a receiver (8), wherein the receiver antennas (antenna 0 . . . 3) are irradiated with a test signal (17), which includes a first signal progression segment, which causes a switching of the receiver antennas (antenna 0 . . . 3) by the diversity circuit (10), and includes a second signal progression segment, which impedes a change in selection of the receiver antenna (antenna 0 . . . 3) by the diversity circuit (10), and by a diagnostic device (1) for selective testing of receiver antennas (antenna 0 . . . 3) in a multi-antenna system (6), which is controlled by a diversity circuit and couplable and/or coupled to a receiver (8), the diagnostic device (1) including a transmitter unit (2) having circuits and/or programming adapted to emit a test signal (17) which includes a first signal progression segment, which triggers a switching of receiver antennas (antenna 0 . . . 3) via the diversity circuit (10), and includes a second signal progression segment, which impedes switching of the receiver antennas (antenna 0 . . . 3) via the diversity circuit (10). Advantageous embodiments are set forth in the characteristics of the dependent claims.

The inventive process is carried out in order to individually test received signals in a multi-antenna system, wherein the coupling of the receiver antennas to a receiver is controlled via a diversity circuit. The receiver antennas are preferably arranged as adjacent receiver antennas in a motor vehicle, which are, for example, integrated in the motor vehicle rear window. The receiver antennas are used to receive for example radio or television signals, alternatively the antenna system can be for WLAN-Accesspoints, GSM- or UMTS-Receiver Stations.

In particular, the multi-antenna system and/or the receiver is designed for receiving FM signals. Preferably, the diversity circuit switches through to the receiver the respective receiver antenna, of which the received signal exhibits the least disturbance and/or the best receiver characteristic.

It is envisioned that the receiver antennas are irradiated with the test signal, wherein the test signal is in particular transmitted wirelessly to the receiver antennas. The test signal is preferably produced in a diagnostic device (1) for selective testing of receiver antennas (antenna 0 . . . 3) in a multi-antenna system (6), which is controlled by a diversity circuit and couplable and/or coupled to a receiver (8), the diagnostic device (1) including a transmitter unit (2) having circuits and/or programming adapted to emit a test signal (17) which includes a first signal progression segment, which triggers a switching of receiver antennas (antenna 0 . . . 3) via the diversity circuit (10), and includes a second signal progression segment, which impedes switching of the receiver antennas (antenna 0 . . . 3) via the diversity circuit (10). Preferably the radiation is carried out in a shielded test space, so that the test signals do not influence radio reception in the environment.

The test signal includes at least a first and a second signal progression segment, which are preferably directly subsequent in the test signal. The first signal progression segment is therein designed such that the diversity circuit is forced to switching the receiver antennas. The second signal progression segment is in contrast so designed, that a switching of the receiver antenna by the diversity circuit is inhibited. Thus, conditions are produced in or on the diversity circuit, which bring about a maintenance of the actual switch condition.

The advantage of the invention lies above all therein, that all branches, that is, all receiver antennas, of a multi-antenna system equipped with a diversity circuit can be tested reproducibly and contactlessly and in particular without having to intervene in the antenna module.

In a preferred embodiment, the process is applied to a multi-antenna system with a scanning-diversity-circuit. In this type of circuit, all receiver antennas of a multi-antenna system access a single common receiver. This type of circuit is most widely employed and can be most economically produced by manufacturers. By targeted search processes the receiver antenna with the best receiver characteristic is switched or patched through to the receiver.

In a preferred embodiment of the process it is envisioned that the test signal is an unmodulated carrier signal. Preferably the frequency of the carrier signal is within a frequency range, in which the multi-antenna system is later employed. In particular the frequency of the carrier signal for receiver antennas, which are later used as radio antennas, is between is 50 and 150 MHz.

In a preferred embodiment of the process it is envisioned that the first signal progression segment of the test signal exhibits an interruption in signal level, or the test signal is reduced relative to a starting level. This collapse in level is preferably so selected with regard to its strength and duration, taking into consideration the employed diversity circuit and its coupling with the receiver, that the diversity circuit in the case of a collapse in the level recognizes a disturbance and switches to the next receiver antenna. Additionally, it can be provided that the collapse in level, in particular the duration of the collapse in the level of the signal, is so selected, that the diversity circuit switches to precisely one subsequent receiver antenna.

The process is advantageously so designed, that the second signal progression segment exhibits a level increase relative to the starting signal level. The increase in level is preferably so selected with respect to its duration and level that, taking into consideration the employed diversity circuit and its connection with the receiver, the diversity circuit evaluates the signal quality as “sufficient” and maintains the actual condition of switching. In particular, the increase in level is selected to be so strong that the switch condition of the diversity circuit is maintained even in the case of a defective receiver antenna.

In a preferred further development of the process the increase in level is in particular designed to be exponentially decreasing and/or the test signal again reaches its starting level after a defined relaxation time. Preferably, the relaxation time is longer than the duration of the signal level collapse.

In an advantageous embodiment of the process an FM-audio impulse is modulated upon the carrier signal during the first signal progression segment and/or overlapping therewith. A variety of commercially available diversity circuits check the received level and/or the presence of high frequency components in the demodulated audio signal of the signal supplied to it, for evaluation of the receive characteristic of a receiver antenna. Stated another way, the received de-modulated audio signal is examined for interference noises (noise) or impulse tips (spikes). The modulated audio impulse is designed in such a manner, that the demodulated audio impulse can be recognized by the diversity circuit as defective.

The present task is further solved by a diagnostic device (1) for selective testing of receiver antennas (antenna 0 . . . 3) in a multi-antenna system (6), which is controlled by a diversity circuit and couplable and/or coupled to a receiver (8), the diagnostic device (1) including a transmitter unit (2) having circuits and/or programming adapted to emit a test signal (17) which includes a first signal progression segment, which triggers a switching of receiver antennas (antenna 0 . . . 3) via the diversity circuit (10), and includes a second signal progression segment, which impedes switching of the receiver antennas (antenna 0 . . . 3) via the diversity circuit (10). The diagnostic device inventively includes a signal provider, which preferably is a transmitter antenna, for transmitting a test signal, as defined above.

The diagnostic device is advantageously further provided with a signal recording unit, which includes a control unit, which is coupled with the transmitter unit and at the same time is couplable and/or coupled with the receiver and/or the diversity-circuit. With the signal recording unit it is possible in the measurement operation to simultaneously record and/or evaluate the test signal and the system response of the multi-antenna system to the test signal. Further, it is able to reset the receiver to a predetermined antenna, as well as to control the transmission of the test signal and thereby to activate or deactivate this.

### BRIEF DESCRIPTION OF THE DRAWINGS

Further details, features, combinations of characteristics, and advantageous effects attributable to the invention can be seen from the following description of a preferred embodiment of the invention and from the figures. These show respectively in schematic representation:

FIG. 1 a measuring device for testing a multi-antenna system with a first embodiment of a diagnostic device and schematic block diagrammatic representation;

FIG. 2 a transmitter unit of the diagnostic device in FIG. 1, likewise in schematic block diagrammatic representation, with an exemplary embodiment of a test signal.

Elements corresponding to each other are assigned the same reference numbers in the figures.

### DETAILED DESCRIPTION OF THE INVENTION

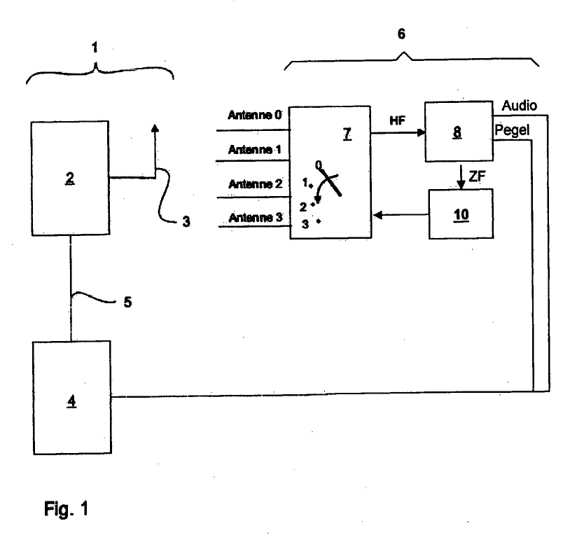

FIG. 1 shows in schematic block diagram on the left side of the illustrative embodiment a diagnostic device 1 which includes a transmitter unit 2 with transmitter antenna 3 and a signal recording until 4, wherein transmitter unit 2 and signal recording unit 4 are connected with each other via a first signal cable 5.

On the right side of FIG. 1 a multi-antenna system 6 is shown in the form of an antenna-diversity-system which is to be tested. The multi-antenna system 6 includes, in this embodiment, four receiver antennas, which are indicated as antenna 0 through antenna 3. The receiver antennas 0 . . . 3 are connected with an antenna circuit 7 which patches through selectively only one of the four receiver antennas 0 . . . 3. In FIG. 1 the antenna switch 7 is so illustrated, that antenna 0 is patched through.

The HF (high frequency) signals coming from antenna 0 are relayed via the antenna switch 7 to a receiver 8, which produces therefrom, in known manner, an IF (intermediate frequency) signal and transmits this to the diversity circuit 10.

The diversity circuit 10 in FIG. 1 is, for example, a TEA6101 or TEA6101/T from Philips Semiconductors. For a detailed description of this IC, reference is made to the data sheet provided by the manufacturer.

The diversity circuit 10 checks, by evaluation of the IF-signal, whether a collapse in level or an audio interference exists. In the case that this type of disturbance is present and therewith satisfies the condition for a bypass switching of the receiver antenna 0 . . . 3, the diversity circuit 10 switches the antenna selector switch 7, beginning from a reference antenna, over to a switch position so that then in FIG. 1 antenna 1 is selected as the receiver.

The signal recording unit 4 is switched in such a manner that the signal level |ZF| and/or the audio signal is detectable by ear. The signal recording unit 4 can optionally record and/or evaluate additional signals of the multi-antenna system 6 for checking or testing. The signal recording unit 4 undertakes a synchronization of the test signal with the test and evaluation signal to be evaluated.

In operation, that is, during checking of the multi-antenna system 6, the test signal is transmitted wirelessly from the transmitter antenna 3 of the transmitter unit 2 to the receiver antenna, namely antenna 0 . . . 3.

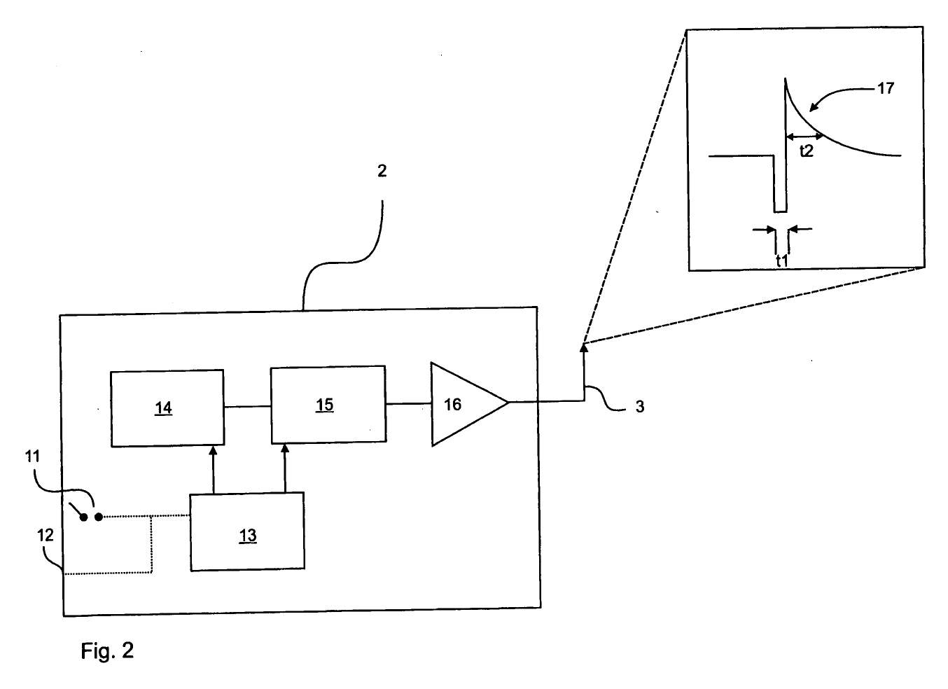

The production, design and effect of the test signal is explained on the basis of FIG. 2. According to FIG. 2, the transmitter unit 2 includes a switch 11 for a manual triggering of the test signal for switching antennas of the receiver antenna 0 . . . 3 in the multi-antenna system 6. In addition to this, an interface or coupling-in location 12 is provided for coupling of an external control for automatic triggering of the test signal. The switch 11 or, as the case may be, the interface point 12 is connected with a signal generator 13, which produces an audio test signal and a level progression signal after actuation of the switch 11 or, as the case may be, activation of the interface 12. The audio test signal is so designed, that it is classified as disturbance during the evaluation by the diversity circuit 10 in FIG. 1. In an FM-oscillator 14 the audio test signal is converted into a FM-signal. The FM-signal is supplied to a PIN-diode attenuator 15, which carries out a signal shaping with a collapse in signal level and a subsequent increase in signal level. The signal shaped in this manner is amplified in the amplifier 16 and emitted as test signal 17 via the transmitter antenna 3.

The progression of the transmitter level of an exemplary test signal 17 is shown on the upper right of FIG. 2. First the test signal is emitted as unmodulated carrier signal with a starting level, so that the diversity circuit 10 maintains its actual switch condition. In order to force the diversity circuit 10 to switch over, the level of the test signal 17 is dropped for a short time by at least 20 dB. The duration of the level collapse t1 lies between 10 and 20 μs and is sufficient that, via the diversity circuit 10, the antenna selector switch 7 switches over by precisely one receiver antenna 0 . . . 3. After a collapse in level, immediately subsequently a level increase of the test signal 17 is introduced, with the goal, to maintain the new switch selection position, that is, to quasi freze the selection. The increase in level lies preferably 20 dB above the original starting level in order to ensure that a switching over of the receiver antennas is prevented even in the case that the new selected receiver antenna is defective and/or only marginally functional. Beginning at the increase in level, the level of the test signal 17 is continuously—that is, without signal interruption—brought back to the starting level, with a relaxation time t2 of, for example, 10 ms or longer.

It can supplementally be provided, that during the collapse in the level, the test signal 17 can supplementally be modulated with an FM-audio-impulse, as was described in association with the signal generator 13, in order to make possible a reliable switching over. The duration of the FM-audio impulse could be, for example 10-50 μs.

Now that the invention has been described, We claim:
1. diagnostic device
2. transmitter unit
3. transmitter antenna
4. signal recording unit
5. first signal cable
6. multi-antenna system
7. antenna selection switch
8. receiver
10. diversity circuit
11. switch
12. interface point
13. signal generator
14. FM-oscillator
15. PIN-diode attenuator
16. amplifier
17. test signal

1-8. (canceled)

9. A process for selective testing of receiver antennas (antenna 0 . . . 3) in a multi-antenna system (6) which is controlled by a diversity circuit (10) and couplable and/or coupled to a receiver (8), said process comprising
irradiating the receiver antennas (antenna 0 . . . 3) with a test signal (17) which includes a first signal progression segment, which triggers a switching of receiver antennas (antenna 0 . . . 3) via the diversity circuit (10), and includes a second signal progression segment, which impedes switching of the receiver antennas (antenna 0 . . . 3) via the diversity circuit (10).

10. A process according to claim 9, wherein the test signal is an unmodulated and/or sectionally unmodulated carrier signal.

11. A process according to claim 9, wherein the first signal progression segment includes a collapse in signal level relative to the starting signal level.

12. A process according to claim 9, wherein the second signal progression segment includes an increase in signal level relative to the starting signal level.

13. A process according to claim 12, wherein the increased signal level continuously declines within a defined relaxation time (t2) to the starting level.

14. A process according to claim 9, wherein an FM-audio signal is modulated upon the carrier signal during the first signal progression segment in order to simulate an audio disturbance.

15. A process according to claim 9, wherein an FM-audio signal is modulated upon the carrier signal during the collapse in signal level in first signal progression segment in order to simulate an audio disturbance.

16. A process for selective testing of receiver antennas (antenna 0 . . . 3) in a multi-antenna system (6) which is controlled by a diversity circuit (10) and couplable and/or coupled to a receiver (8), said process comprising
defining a signal progression that will trigger a switching of receiver antennas (antenna 0 . . . 3) via the diversity circuit (10), and defining a signal progression segment that will impede switching of the receiver antennas (antenna 0 . . . 3) via the diversity circuit (10), and
irradiating the receiver antennas (antenna 0 . . . 3) with a test signal (17) which includes a first signal progression segment, which triggers a switching of receiver antennas (antenna 0 . . . 3) via the diversity circuit (10), and includes a second signal progression segment, which impedes switching of the receiver antennas (antenna 0 . . . 3) via the diversity circuit (10).

17. A diagnostic device (1) for selective testing of receiver antennas (antenna 0 . . . 3) in a multi-antenna system (6), which is controlled by a diversity circuit and couplable and/or coupled to a receiver (8), the diagnostic device (1) including a transmitter unit (2) having circuits and/or programming adapted to emit a test signal (17) which includes a first signal progression segment, which triggers a switching of receiver antennas (antenna 0 . . . 3) via the diversity circuit (10), and includes a second signal progression segment, which impedes switching of the receiver antennas (antenna 0 . . . 3) via the diversity circuit (10).

18. A diagnostic device (1) according to claim 17, including a signal recording unit (4), which is coupled by circuit with the transmitter unit (2) and is couplable with the receiver (8) and/or the diversity circuit (10), so that signals from the transmitter unit (2) and the receiver (8) and/or the diversity circuit (10) can be simultaneously recorded.
